(19) United States
(12) Patent Application Publication
(10) Pub. No.: US 2010/0079676 A1
(43) Pub. Date: Apr. 1, 2010

(54) Providing Multi-User Views

(75) Inventors: Barry A. Kritt, Raleigh, NC (US); Douglas A. Law, Chapel Hill, NC (US); Thomas S. Mazzeo, Durham, NC (US); Rodney E. Shepard, II, Durham, NC (US)

Correspondence Address: Marcia L. Doubet Law Office, P.O. Box 422859, Kissimmee, FL, 34742-2859, US

(73) Assignee: INTERNATIONAL BUSINESS MACHINES CORPORATION, Armonk, NY (US)

(21) Appl. No.: 12/240,689

(22) Filed: Sep. 29, 2008

(51) Int. Cl. H04N 5/262

(52) U.S. Cl. 348/598; 348/E05.051

(57) ABSTRACT

Providing multiple interleaved views for multiple viewers who are using a single display. The display may be, for example, the display of a computing device such as a laptop computer. Alternatively, the display may be the display of a television, gaming device, a projection screen, and so forth. Shutter glasses are synchronized to a display that interleaves frames from multiple different streams, enabling the wearer to perceive the frames of a single one of the multiple streams. In one aspect, inverse frames are applied to public frames and the result is interleaved with positive frames, such that a viewer not wearing shutter glasses perceives only the public frames. In another aspect, frames from multiple private streams are interleaved without use of public frames.

### BACKGROUND OF THE INVENTION

The present invention relates to displayed media, and deals more particularly with providing multiple interleaved views for multiple viewers who are using a single display.

### BRIEF SUMMARY OF THE INVENTION

The present invention is directed to providing multiple interleaved views for viewers using a single display. In one aspect, this comprises: applying an inverse of each frame of a first image stream to corresponding frames of a public image stream, thereby creating a first collection of frames; applying an inverse of each frame of a second image stream to corresponding frames of the public image stream, thereby creating a second collection of frames; interleaving the frames of the first image stream, the first collection of frames, the frames of the second image stream, and the second collection of frames, thereby creating an interleaved image stream; synchronizing a first pair of shutter glasses to open while the frames of the first image stream are displayed, from the interleaved image stream, on the single display, such that a wearer of the first pair of shutter glasses views only the first image stream; synchronizing a second pair of shutter glasses to open while the frames of the second image stream are displayed, from the interleaved image stream, on the single display, such that a wearer of the second pair of shutter glasses views only the second image stream; and wherein the frames of the public image stream are viewable as a public view, from the interleaved image stream, for a viewer not wearing shutter glasses. The first stream and the second stream may contain frames with sensitive content.

In another aspect, this comprises: a single display device; an image stream comprising frames of a first image stream interleaved with frames of a second image stream, wherein the frames of the first image stream and the frames of the second image stream are sequentially related except in a portion thereof, the frames of the first image stream providing a first version of the portion and the frames of the second image stream providing a second version of the portion; and a controller adapted for transmitting a first signal to a first pair of shutter glasses to synchronize the first pair of shutter glasses to open when the interleaved frames of the first image stream are displayed, from the image stream, on the single display device and to close otherwise, such that a wearer of the first pair of shutter glasses views only the first image stream and the first version of the portion and for transmitting a second signal to a second pair of shutter glasses to synchronize the second pair of shutter glasses to open when the interleaved frames of the second image stream are displayed, from the image stream, on the single display device and to close otherwise, such that a wearer of the second pair of shutter glasses views only the second image stream and the second version of the portion. The versions may provide, for example, closed captioning text in multiple languages or subtitles in multiple languages. The image stream may remain viewable, from the single display device, by a viewer not wearing shutter glasses, such that the viewer not wearing shutter glasses views the first and second portions as being blurred together.

In either aspect, the frames may contain sensitive content. Either aspect may be extended beyond two non-public image streams.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a sample image stream comprised of interleaved frames that are intended for multiple viewers, according to one aspect of the present invention;

FIGS. 2A, 2B, and 2C illustrate how different viewers perceive the frames of the sample image stream in FIG. 1, depending on use of shutter glasses by the viewer;

FIG. 3 illustrates a sample configuration of components, where this configuration corresponds to the example scenario discussed with reference to FIGS. 1 and 2A-2C;

FIG. 4 illustrates a sample image stream comprised of interleaved frames that are intended for multiple viewers, according to another aspect of the present invention;

FIGS. 5A and 5B illustrate how different viewers wearing shutter glasses perceive the frames of the sample image stream in FIG. 4;

FIG. 6 illustrates a sample configuration of components, where this configuration corresponds to the example scenario discussed with reference to FIGS. 4 and 5A-5B;

FIGS. 7-8 provide flowcharts depicting logic that may be used when implementing an embodiment of the present invention;

FIG. 9 depicts a data processing system suitable for storing and/or executing program code; and

FIG. 10 depicts a representative networking environment in which one or more embodiments of the present invention may be used.

### DETAILED DESCRIPTION OF THE INVENTION

Embodiments of the present invention are directed toward displayed media, and more particularly to providing multiple interleaved views for multiple viewers who are using a single display. The display may be, for example, the display of a computing device such as a laptop computer. Alternatively, the display may be the display of a television, gaming device, a projection screen, and so forth. (The terms “viewer” and “user” are used interchangeably herein to refer to a human who is viewing a display.)

An embodiment of the present invention enables applications having multiple users to present individualized, multi-user views. That is, multiple users view the same physical screen, but each perceives individualized content in the view. Examples of applications where an embodiment of the present invention may be used include, by way of illustration but not of limitation, the following:
Video games with multiple users. Each user can therefore see unique information, and this unique information is kept private or secret from other simultaneous users of that game. When playing a video football game, for example, one player can restrict his offensive and defensive play selections from being viewed by his opponent. As another example, power levels of characters for a game can be viewed privately in this manner.
Sharing displays or projection screens. A shared display for viewing a movie in an airplane may now provide different movies simultaneously, for example, enabling viewers to choose which of the movies they wish to see.
Views with subtitles or closed caption text. Multiple subtitles may be provided on the interleaved frames, each in a different language, for example. Similarly, closed caption text can be provided on the interleaved frames, where this text is in multiple languages. And, a view without the subtitles or closed caption text may be provided simultaneously from the same display.

It may be desirable to restrict views of displayed information for security and/or privacy considerations. When using a computer—particularly when using mobile computing devices such as laptop computers or when working in an open landscape work environment (e.g., in a work area without physical walls)—a privacy or security exposure may arise when information displayed on the display of the computing device can be viewed, whether intentionally or inadvertently, by others. For example, if the computer user is on an airplane, someone in the adjacent seat or in the next row might be able to view the displayed information. As another example, information may be viewable to others when the computer is used in other public places. If the computer user is merely browsing publicly-available information, then ability of others to see that information is not typically of concern. However, if the computer user is viewing sensitive information, a privacy or security exposure arises when that information can be viewed by others. The computer user might be typing a password, for example, and would not like for others to be able to see this typed information.

One known approach for dealing with this situation is to add a mechanical screening device to the computer, where this screening device is designed to restrict visibility from the periphery of the device. However, there are a number of drawbacks with this approach. As one drawback of these screening devices, information may be still viewable to others who are behind the computer user (e.g., in an airplane, classroom, and so forth). As another drawback, the screening devices may be awkward to work with, particularly in situations where mobility of the computer user is restricted (such as a seat of an airplane). Furthermore, the screening devices tend to be limited to use with computing devices having a particular display size, so that they are often not portable from one computing device to another, which may require the computer user to repeatedly invest in different screening devices (and perhaps corresponding adapters and mounting hardware as well).

By contrast, an embodiment of the present invention provides views of displayed information where the sensitive content is viewable only to selected viewers, as will be described.

Specially-adapted glasses are used with an embodiment of the present invention, where these glasses are shuttered on an off by a controller or device driver. The glasses therefore act as filters for viewing displayed information, whereby the wearer can see a view of a display when the shutters are opened but cannot see the view when the shutters are closed. Such glasses, sometimes referred to as “ferroelectric shutter glasses” (or simply “shutter glasses”), and the manner in which such glasses operate, are known in the art. The lenses of such glasses typically use liquid crystal display, or “LCD”, technology. The shuttering on and off of the glasses may comprise the lenses of the glasses switching between clear and opaque.

An embodiment of the present invention provides a novel approach for sending an image stream to a display, where this image stream is to be viewed using shutter glasses. An embodiment of the present invention interleaves images or frames for multiple viewers in a single stream, and the shutter glasses enable separating the images or frames intended for different viewers. (The terms “images” and “frames” are used interchangeably herein, and the term “image stream” is used to refer to a streaming collection of images/frames.)

In one aspect, an embodiment of the present invention interleaves sensitive images for multiple users while also providing a view of non-sensitive images. These non-sensitive images are referred to herein as “public” images, while the sensitive images are referred to herein as “private” images or “secret” images. Users wearing shutter glasses are therefore able to see the private images and users who are not wearing shutter glasses see the public images.

In this aspect, so-called “negative” or “inverse” images are used. A well-known example of a negative image is the negative of a photograph. More generally, a negative of an image is an inverse of the image that, when applied to the image, effectively cancels the image from being viewable. Algorithms for constructing an inverse of an image are known in the art, and such algorithms may be leveraged by an embodiment of the present invention.

The notation “S1(n)” is used herein to refer to a secret image “n” in an image stream “S1” that is intended for viewing by a “User 1”, and “S2(m)” refers to a secret image “m” in an image stream “S2” that is intended for viewing by a “User 2” (where “n” and “m” may take on numeric or alphabetic values in the examples provided herein). Accordingly, an image stream intended for User 1 is comprised of images denoted herein as “S1(n), S1(n+1), S1(n+2), . . . ” and a different image stream intended for User 2 is comprised of images denoted herein as “S2(m), S2(m+1), S2(m+2), . . . ”.

The notation “P” is used herein to refer to a public image, and the notation “−S1(n)” refers to the inverse of image “S1(n)”. Accordingly, the notation “P−S1(n)” refers to a public image “P” to which the inverse image “−S1(n)” has been applied according to this aspect of the present invention. In other words, the negative of the image S1(n) is applied to the public image P, which is mathematically equivalent to subtracting the image S1(n) from the public image P. This subtraction may also be referred to as “differencing” the S1(n) image from the public image. It is known that the human eye cannot perceive individual images beyond a certain refresh rate of a display device. This phenomenon is sometimes referred to as image persistence. Displaying a sequence of images “S1(n), P−S1(n), S1(n+1), P−S1(n+1), S1(n+2), P−S1(n+2)” faster than such refresh rate therefore causes the secret images “S1(x)” to be cancelled out by their corresponding inverse images “−S1(x)”, such that only the remaining public images “P” are perceived by someone who is viewing this sequence. (For ease of reference, discussions herein omit a syntax “(n)” to distinguish among individual frames when discussing the frames of the public image “P”, although it should be understood that the public images may comprise frames in which the image is changing; alternatively, the public images may comprise a single image that is used repeatedly.)

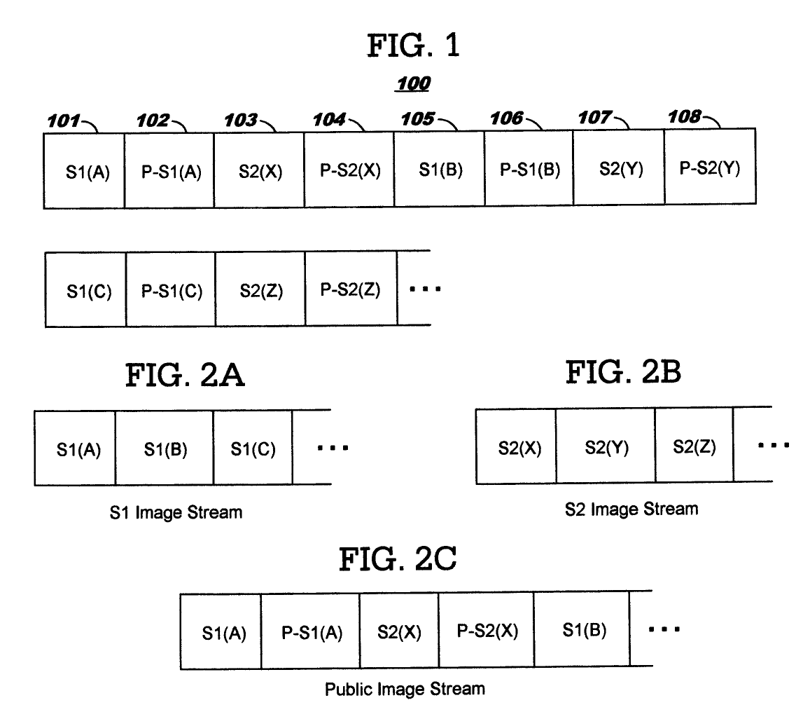

FIG. 1 illustrates a sample image stream 100 comprised of interleaved frames that are intended for multiple users, according to this aspect of the present invention. In this example, secret images are provided in the stream for 2 different viewers, and public images are also provided in this same image stream for public viewers. The composition of this sample image stream 100 will now be discussed in more detail.

A first frame 101 of stream 100 contains an image “S1(A)”, and a second frame 102 of stream 100 contains an image “P−S1(A)”. A third frame 103 of stream 100 contains an image “S2(X)”, and a fourth frame 104 of stream 100 contains an image “P−S2(X)”. Similarly, a fifth frame 105 of stream 100 contains an image “S1(B)”, a sixth frame 106 of stream 100 contains an image “P−S1(B)”, a seventh frame 107 of stream 100 contains an image “S2(Y)”, an eighth frame 108 of stream 100 contains an image “P−S2(Y)”, and so forth.

Thus, as illustrated in this sample stream 100, the interleaved images that are intended for viewing by user 1 form an image stream “S1(n)”, and the frames of this stream appear in every fourth frame of stream 100, starting from the first frame. Similarly, the interleaved images that are intended for viewing by user 2 form an image stream “S2(m)”, and the frames of this stream appear in every fourth frame of stream 100, starting from the third frame. The public frames (that is, the frames containing the non-sensitive content) appear in every other frame of stream 100, after having a secret image applied thereto, starting from the second frame.

See FIGS. 2A, 2B, and 2C, which illustrate views comprising the frames that are viewable to user 1, user 2, and a public viewer, respectively, when users 1 and 2 view the stream 100 with shutter glasses and the public viewer views the stream 100 without such glasses. As discussed earlier, the full sequence of images “S1(A), P−S1(A), S2(X), P−S2(X), S1(B), P−S1(B), . . . ” shown in FIG. 2C will be perceived by someone who is not wearing shutter glasses as if the image stream contained only images “P” because the interleaved secret images will be cancelled out when the stream is displayed at a proper refresh rate. Note that the public viewer will actually perceive the intermixed frames as P/2. That is, the frame content of a particular frame will be reduced in brightness by 50 percent. (A “proper” refresh rate may be, for example, 120 Hz.)

Each of the users for whom secret frames are interleaved in the image stream views those secret frames by wearing shutter glasses that are synchronized to open when that user's secret frames are displayed, and to close otherwise. Accordingly, in the example, the glasses for user 1 will open for the first frame, then close for 3 frames, then open for another frame, then close for 3 frames, and so forth. Similarly, the glasses for user 2 will open for the third frame, then close for 3 frames, then open for another frame, close for 3 frames, and so forth.

The shutter glasses may be synchronized with the image stream using a device driver or controller which sends signals to the glasses. The signals may be sent using wireless or wired means. As one example of wired technology, the glasses may be plugged into a Universal Serial Bus (“USB”) port of a device in which the device driver or controller operates. As one example of wireless technology, the shutter glasses may include a receiver for Bluetooth signals that are sent from the device driver or controller.

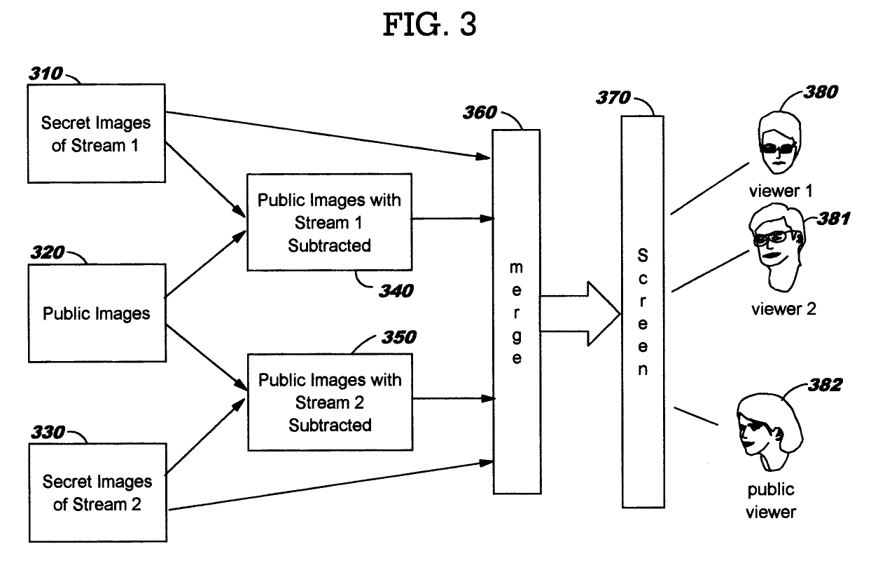

FIG. 3 illustrates a sample configuration of components, where this configuration corresponds to the example scenario discussed above with reference to FIGS. 1 and 2A-2C. A first image source provides secret images comprising stream 1 (see 310), a second image source provides public images (see 320), and a third image source provides secret images comprising stream 2 (see 330). While the sources are illustrated in FIG. 3 as being distinct, this is by way of illustration but not of limitation. It may happen, in a particular environment, that a single source provides all of the image streams 310, 320, 330. As another alternative, a single source might provide the secret image streams 310, 330 while a separate source provides the public image stream 320.

A component 340 is depicted in FIG. 3 as performing the subtraction of secret images comprising stream 1 from the public images, and another component 350 is depicted as performing the subtraction of secret images comprising stream 2 from the public images. While the components 340, 350 are illustrated in FIG. 3 as being distinct, this is by way of illustration but not of limitation. It may happen, in a particular environment, that a single component performs the subtraction for both secret image streams.

FIG. 3 shows the various image streams as being sent to a merge component 360, which merges (i.e., interleaves) the images into a single image stream and forwards that image stream to a single screen 370 for display. Although component 360 is illustrated in FIG. 3 as a standalone component, the component 360 may be provided as a component of the screen 370 circuitry as one alternative. As another alternative, the merge functionality of component 360 may be provided by components 340, 350 (including a scenario where the subtraction functionality of components 340, 350 is provided by a single component).

FIG. 3 shows 3 different viewers 380, 381, 382. In this example, viewer 1 at 380 wears shutter glasses that are synchronized to the interleaved secret images comprising stream 1 (see 310), and viewer 2 at 381 wears shutter glasses that are synchronized to the interleaved secret images comprising stream 2 (see 320). That is, the shutter glasses of these 2 viewers open for the frames intended for those viewers and close when other frames are displayed. These viewers therefore perceive the image stream displayed on screen 370 as if it contains only the separate image streams shown in FIGS. 2A and 2B, respectively. Viewer 3 at 382 is not wearing shutter glasses, in this example, and viewer 3 therefore sees the public image stream shown in FIG. 2C (and as has been discussed, the interleaved secret images are cancelled out by applying inverse frames, and viewer 3 therefore perceives only the public images “P” from the stream).

A number of optional features may be used with the above-described aspect (for example, to enhance security of the private images). Several of these optional features will now be discussed.

In a first optional feature, the position of the interleaved frames may be randomly altered, as opposed to the fixed sequencing pattern illustrated in FIG. 1. The controller or device driver may send a signal to inform the shutter glasses of the timing at which they should open and close. This random altering reduces the likelihood of an unauthorized viewer obtaining shutter glasses using the glasses to “eavesdrop” on one of the secret image streams contained within the overall image stream, as the glasses would not be able to predict which ones of the frames would provide the content for a particular secret image stream.

In a second optional feature, frames may be logically grouped, and individual frames within the group may be randomly selected for containing particular frame content. For example, with reference to the image stream 100 of FIG. 1, it can be seen that 4 frames are used to transmit a single secret frame to user 1 and a single secret frame to user 2, and the remaining 2 frames transmit public images (with inverse images applied thereto). Rather than providing the secret frames in the first and third of the 4 frames, as shown in FIG. 1, the positioning of the secret frames may be altered. For example, the frame sequence shown in FIG. 1 as a repetitive 1, 2, 3, 4 sequence might instead be changed to 1, 2, 3, 4 followed by 2, 4, 1, 3 followed by 1, 4, 3, 2, and so forth. The controller or device driver may send a signal to inform the shutter glasses of the timing at which they should open and close. As contrasted to the first optional feature discussed above, the logical grouping of frames in this second approach yields a maximum fixed time between positive (i.e., secret) and negative images, thereby reducing flickering of the images while still preventing unauthorized viewers from synchronizing shutter glasses to the overall image stream.

In a third optional feature, instead of changing the positioning of the secret frames as in the first and second optional features, the display refresh start time may be varied by a small amount (for example, plus or minus 5 percent). Optionally, this third optional feature may be used in combination with either of the first or second optional features. Changing the display refresh start time reduces the likelihood of an unauthorized viewer being able to synchronize his or her shutter glasses to the image stream.

Security of the secret image streams may be increased by pseudo-randomly altering a strobe rate of the display and/or the frame content sequence.

While this aspect has been described with regard to a sample scenario involving 2 private streams and 1 public stream (i.e., one stream of public frames, to which inverse frames corresponding to the private streams are applied), this is by way of illustration and not of limitation. Alternatively, more than 2 private streams may be interleaved, with each frame of each private stream having a corresponding frame where that private image is subtracted from a frame of the public stream.

In another aspect of the present invention, private images are provided to multiple users in an image stream that does not include public images to which an inverse of the private images is applied. This aspect may be used, for example, when the content of the private images is not sensitive and it is therefore not necessary to prevent viewing of that content. In fact, it may be desirable in some scenarios for users without shutter glasses to be able to see private images from an interleaved image stream.

As one example, suppose the image stream is for displaying a movie on a shared display. This aspect of the present invention may be used, for example, to simultaneously provide subtitles in different languages within the interleaved frames of the stream (and alternative uses are discussed below). The content of the image streams is therefore not necessarily “secret” or “private” in the sense of confidential information, but rather the goal is to keep the different image streams separate, or private, from one another so as to provide a coherent viewing experience for multiple viewers who are simultaneously viewing different ones of the interleaved images.

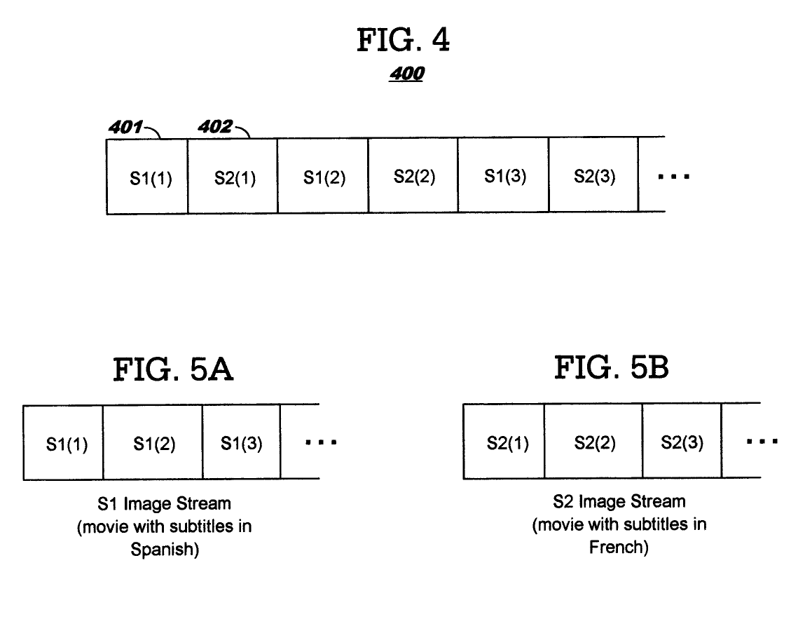

FIG. 4 illustrates a sample image stream 400 comprised of interleaved frames that are intended for multiple users, according to this aspect of the present invention. In this example, secret images are provided in the stream for 2 different viewers. (The interleaved streams of FIG. 4 are referred to herein as “secret” streams, although their content may not be secret or sensitive, for consistency with the nomenclature used to describe the first aspect.) The composition of this sample image stream 400 will now be discussed in more detail.

A first frame 401 of stream 400 contains an image “S1(1)”, and a second frame 402 of stream 400 contains an image “S2(1)”. In this notation, “S1” is the first secret image stream, and “S2” is the second secret image stream, “S1(n)” is a particular frame with the first secret image stream, and “S2(n)” is a particular frame within the second image stream. The frames of the sample image stream 400 therefore alternate between frames of S1 and frames of S2 in this example, as can be seen in FIG. 4.

Thus, as illustrated in this sample stream 400, the interleaved images that form image stream “S1(n)”, for viewing by viewer 1, appear in every other frame of stream 400, starting from the first frame. Similarly, the interleaved images that form image stream “S2(n)”, for viewing by viewer 2, appear in every other frame of stream 400, starting from the second frame. The shutter glasses of these viewers are therefore set to open and close for each alternate frame, starting from their respective initial frames.

Suppose that the images of stream S1 provide frames of a particular movie with subtitles in Spanish, and the images of stream S2 provide frames of that same movie with subtitles in French. The glasses of viewer 1 therefore open for the images having the Spanish subtitles, and the glasses of viewer 2 open for the images having the French subtitles. FIGS. 5A and 5B illustrate the view of image stream 400 as perceived by viewers 1 and 2, respectively. (Note that because each viewer sees one of their frames in every other refresh cycle in this example, a relatively small amount of flicker occurs.)

A viewer without shutter glasses will see all of the frames from image stream 400. Because of the human eye's image persistence, the alternating S1(n), S2(n) images will blur together for this viewer. The frame sequence perceived by this viewer will be [S1(n)+S2(n)]/2 (that is, the viewer will perceive an average of the frames from both secret streams), which will allow the viewer to have some perception of the subtitles, although neither the Spanish or French subtitles of the example scenario will appear clearly. (This may be acceptable, for example, if the viewer is watching the movie in his or her native language and does not need to refer to the subtitles.) Note that the portion of the movie that is above the subtitles will be generally the same in each frame S1(x) as in the corresponding frame S2(x), in this example scenario where a single movie is being displayed. (It should be noted that some incremental difference may occur in the portion above the subtitles, such as reflecting frame-to-frame motion. The corresponding frames of the streams S1, S2 may therefore be considered as “sequentially related”, rather than as identical.) The public viewer will therefore see this upper portion of the movie with no reduction in brightness and with no increase in flicker.

The viewers of image stream 400 who are wearing shutter glasses may select which of the streams S1, S2 they wish to see by selecting a channel from among multiple offered channels, for example, where the selection of the channel indicates how the shutter glasses should synchronize to different ones of the streams.

As one alternative to using this aspect for providing subtitles in different languages, the different image streams may be used to simultaneously provide closed captioning in different languages within the interleaved frames of the stream. Closed captioning for particular images might be provided in English in the frames of stream S1 and in Spanish for corresponding frames of stream S2, for example. A viewer who is not wearing shutter glasses will then perceive blurring of the closed captioning text (that is, the closed captioning text of the various languages will blur together), but will be able to see the upper portion of the frames (i.e., the area above the closed captioning) clearly, with no reduction in brightness and no flicker.

As another alternative, this aspect may be used for interleaving more than one movie in a single image stream for display on a shared screen (such as a shared display screen in an airplane), thereby allowing viewers to simultaneously view different movies from that single shared screen. When interleaving frames according to this alternative, it may happen that the interleaved frames do not contain subtitles or closed captioning.

As yet another alternative, the interleaved frames for one of the streams may provide a movie with neither subtitles or closed captioning, while another of the streams provides that same movie with subtitles or with closed captioning.

It should also be noted that an embodiment of the present invention may interleave frames with subtitles or closed captioning, using the first above-described aspect, where the public image comprises corresponding frames without subtitles or closed captioning and the differencing then subtracts the subtitles or closed captioning from the public frames to thereby provide a public viewer with an image stream that has no perceptible subtitles or closed captioning.

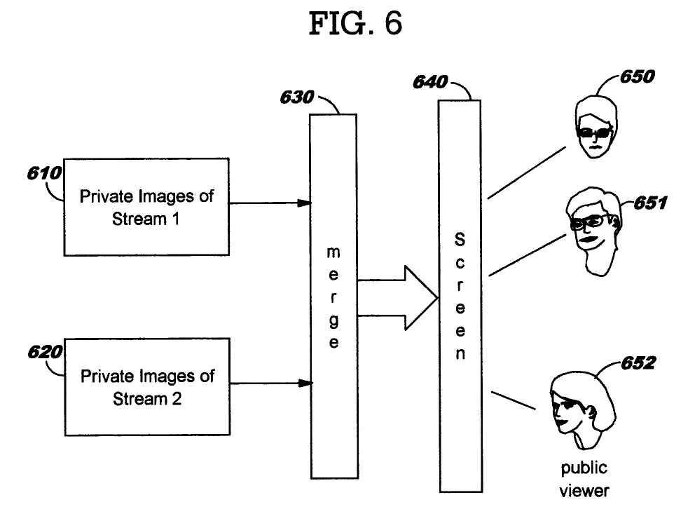

FIG. 6 illustrates a sample configuration of components, where this configuration corresponds to the example scenario discussed above with reference to FIGS. 4 and 5A-5B. A first image source provides private images comprising stream 1 (see 610), and a second image source provides private images comprising stream 2 (see 620). While the sources are illustrated in FIG. 6 as being distinct, this is by way of illustration but not of limitation. It may happen, in a particular environment, that a single source provides both of the image streams 610, 620.

FIG. 6 shows the private image streams as being sent to a merge component 630, which interleaves the images into a single image stream and forwards that image stream to a single screen 640 for display. Although component 630 is illustrated in FIG. 6 as a standalone component, the component 630 may be provided as a component of the screen 640 circuitry as one alternative.

FIG. 6 shows 3 different viewers 650, 651, 652. In this example, viewer 1 at 650 wears shutter glasses that are synchronized to the interleaved private images comprising stream 1 (see 610), and viewer 2 at 651 wears shutter glasses that are synchronized to the interleaved private images comprising stream 2 (see 620). That is, the shutter glasses of these 2 viewers open for the frames intended for those viewers and close when other frames are displayed. These viewers therefore perceive the image stream displayed on screen 640 as if it contained only the separate image streams shown in FIGS. 5A and 5B, respectively. Viewer 3 at 652 is not wearing shutter glasses, in this example, and viewer 3 therefore perceives the image stream as containing all of the frames from the stream 400 as illustrated in FIG. 4.

While this aspect has been discussed with reference to interleaving frames of 2 streams, this is by way of illustration but not of limitation, and an embodiment of this aspect may flexibly adapt to more than 2 different streams.

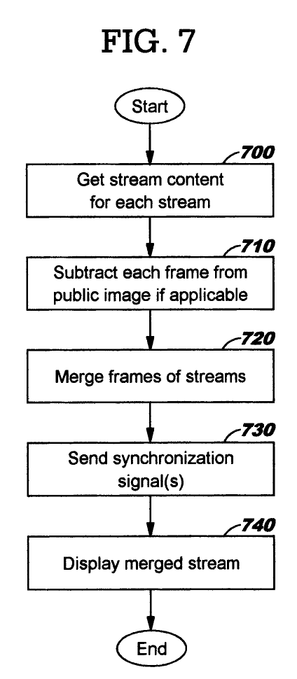

FIG. 7 provides a flowchart depicting logic which may be used when implementing an embodiment of the present invention. This processing begins at Block 700, where the content for the various streams is obtained. With reference to the first above-described aspect, for example, this comprises obtaining each of the secret streams as well as the public stream; for the second above-described aspect, this comprises obtaining each of the private streams. (It may happen that individual frames are obtained and processed iteratively, and the approach shown in FIG. 7—for example, referring to obtaining streams as opposed to frames—should therefore be considered as illustrative but not limiting.)

Block 710 subtracts the frames of the secret streams from corresponding frames of the public image stream, when FIG. 7 is used with an embodiment of the first above-described aspect (and this block may be omitted in an embodiment of the second above-described aspect).

Block 720 merges the frames of the various streams, as has been discussed above with reference to the examples of merge component 360 of FIG. 3 and merge component 630 of FIG. 6.

Block 730 sends a synchronization signal or signals to shutter glasses, enabling those glasses to synchronize with the interleaved frames for a particular one of the secret or private streams. Block 740 then displays the stream that results from the merge operation in Block 720, after which the processing of FIG. 7 ends.

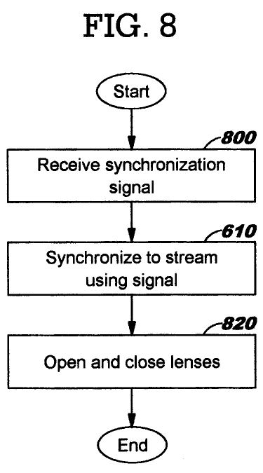

FIG. 8 provides a flowchart depicting logic which may be used for controlling shutter glasses, according to an embodiment of the present invention. This processing begins at Block 800, where the glasses receive a synchronization signal from the device driver or controller. This signal is used to synchronize the shutter glasses to a displayed stream (Block 810). The shutter glasses then open and close (Block 820) accordingly, enabling the viewer to perceive the intended interleaved frames from the displayed stream. The processing of FIG. 8 then exits.

When implementing one of the above-described optional features, the synchronization signal may be sent to the shutter glasses multiple times for viewing a particular image stream. In this approach, the processing of FIG. 8 is performed in an iterative manner.

As will be appreciated by one of skill in the art, selected components of the present invention may be provided as methods, systems, and/or computer program products comprising computer-readable program code. Accordingly, the present invention may take the form of an entirely hardware embodiment. An embodiment combining software and hardware aspects might be used alternatively. Or, components of the present invention may be provided in a software embodiment (as described in the appended claims).

Furthermore, components of the invention may take the form of a computer program product accessible from computer-usable or computer-readable media providing program code for use by, or in connection with, a computer or any instruction execution system. For purposes of this description, a computer-usable or computer-readable medium can be any apparatus that can contain, store, communicate, propagate, or transport a program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, removable computer diskette, random access memory (“RAM”), read-only memory (“ROM”), rigid magnetic disk, and optical disk. Current example of optical disks include compact disk with read-only memory (“CD-ROM”), compact disk with read/write (“CD-R/W”), and DVD.

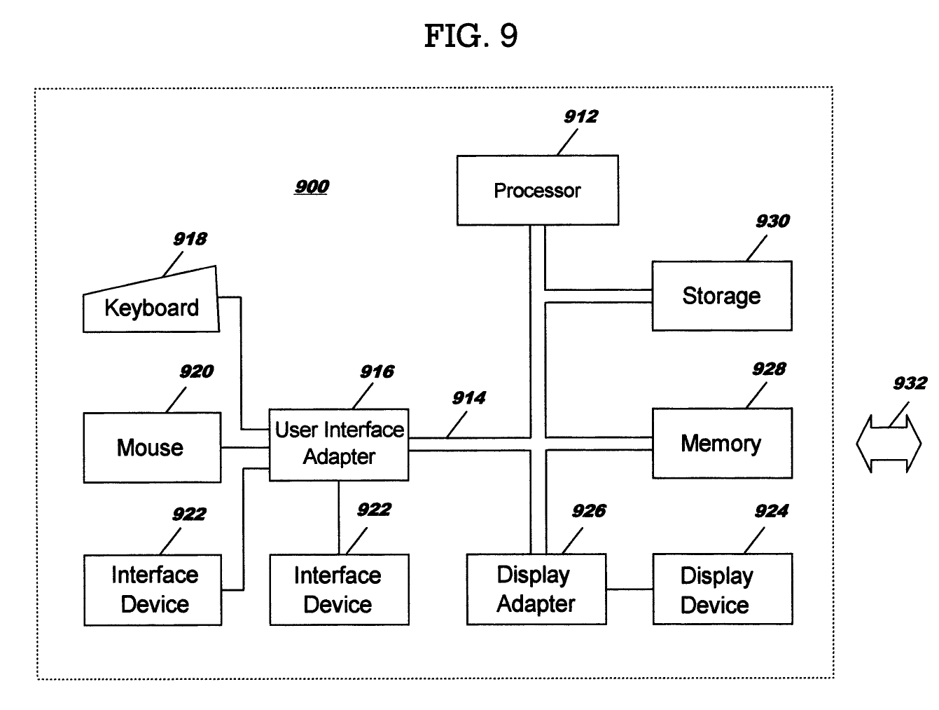

Referring now to FIG. 9, a data processing system 900 suitable for storing and/or executing program code includes at least one processor 912 coupled directly or indirectly to memory elements through a system bus 914. The memory elements can include local memory 928 employed during actual execution of the program code, bulk storage 930, and cache memories (not shown) which provide temporary storage of at least some program code in order to reduce the number of times code must be retrieved from bulk storage during execution.

Input/output (I/O”) devices (including but not limited to keyboards 918, displays 924, pointing devices 920, other interface devices 922, etc.) can be coupled to the system either directly or through intervening I/O controllers or adapters (916, 926).

Network adapters may also be coupled to the system to enable the data processing system to become coupled to other data processing systems or remote printers or storage devices through intervening private or public networks (as shown generally at 932). Modems, cable modem attachments, wireless adapters, and Ethernet cards are just a few of the currently-available types of network adapters.

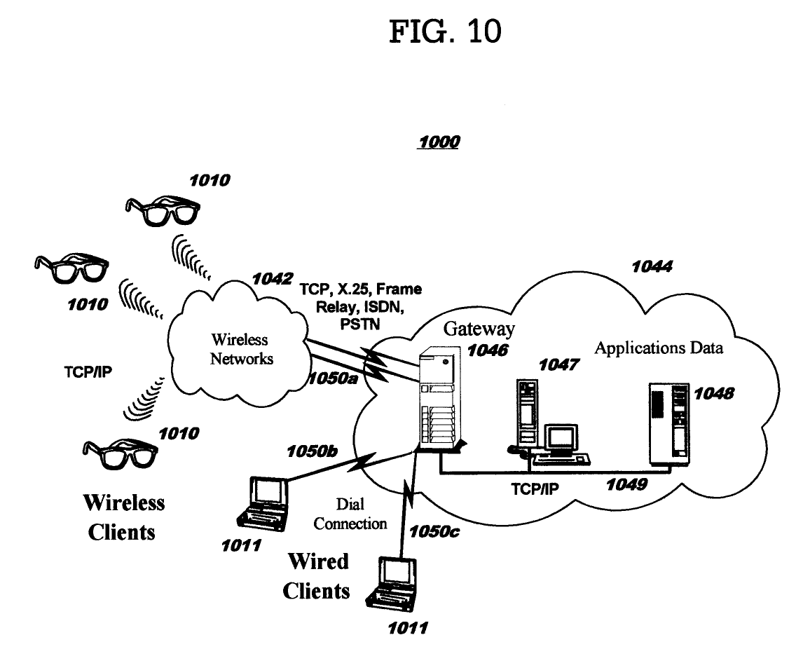

FIG. 10 illustrates a data processing network environment 1000 in which the present invention may be practiced. The data processing network 1000 may include a plurality of individual networks, such as wireless network 1042 and network 1044. A plurality of shutter glasses 1010 (as well as other devices, not shown) may communicate over wireless network 1042, and a plurality of devices, shown in the figure (by way of illustration) as workstations 1011, may communicate over network 1044. Additionally, as those skilled in the art will appreciate, one or more local area networks (“LANs”) may be included (not shown), where a LAN may comprise a plurality of devices coupled to a host processor.

Still referring to FIG. 10, the networks 1042 and 1044 may also include mainframe computers or servers, such as a gateway computer 1046 or application server 1047 (which may access a data repository 1048). A gateway computer 1046 serves as a point of entry into each network 1044. The gateway 1046 may be preferably coupled to another network 1042 by means of a communications link 1050a. The gateway 1046 may also be directly coupled to one or more workstations 1011 using a communications link 1050b, 1050c, and/or may be indirectly coupled to such devices. The gateway computer 1046 may be implemented utilizing an Enterprise Systems Architecture/370™ available from the International Business Machines Corporation (“IBM®”), an Enterprise Systems Architecture/390® computer, etc. Depending on the application, a midrange computer, such as an iSeries®, System i™, and so forth may be employed. (“Enterprise Systems Architecture/390” and “iSeries” are registered trademarks of IBM in the United States, other countries, or both, and “System i” is a trademark of IBM.)

The gateway computer 1046 may also be coupled 1049 to a storage device (such as data repository 1048).

Those skilled in the art will appreciate that the gateway computer 1046 may be located a great geographic distance from the network 1042, and similarly, the scanner devices 1010 and/or workstations 1011 may be located some distance from the networks 1042 and 1044, respectively. For example, the network 1042 may be located in California, while the gateway 1046 may be located in Texas, and one or more of the workstations 1011 may be located in Florida. The scanner devices 1010 may connect to the wireless network 1042 using a networking protocol such as the Transmission Control Protocol/Internet Protocol (“TCP/IP”) over a number of alternative connection media, such as cellular phone, radio frequency networks, satellite networks, etc. The wireless network 1042 preferably connects to the gateway 1046 using a network connection 1050a such as TCP or User Datagram Protocol (“UDP”) over IP, X.25, Frame Relay, Integrated Services Digital Network (“ISDN”), Public Switched Telephone Network (“PSTN”), etc. The workstations 1010 may connect directly to the gateway 1046 using dial connections 1050b or 1050c. Further, the wireless network 1042 and network 1044 may connect to one or more other networks (not shown), in an analogous manner to that depicted in FIG. 10.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

1. A method of providing multiple interleaved views for viewers using a single display, comprising:
applying an inverse of each frame of a first image stream to corresponding frames of a public image stream, thereby creating a first collection of frames;
applying an inverse of each frame of a second image stream to corresponding frames of the public image stream, thereby creating a second collection of frames;
interleaving the frames of the first image stream, the first collection of frames, the frames of the second image stream, and the second collection of frames, thereby creating an interleaved image stream;
synchronizing a first pair of shutter glasses to open while the frames of the first image stream are displayed, from the interleaved image stream, on the single display, such that a wearer of the first pair of shutter glasses views only the first image stream;
synchronizing a second pair of shutter glasses to open while the frames of the second image stream are displayed, from the interleaved image stream, on the single display, such that a wearer of the second pair of shutter glasses views only the second image stream; and
wherein the frames of the public image stream are viewable as a public view, from the interleaved image stream, for a viewer not wearing shutter glasses.

2. The method according to claim 1, wherein the interleaving comprises following each of the frames of the first image stream with a corresponding one of the frames of the first collection and following each of the frames of the second image stream with a corresponding one of the frames of the second collection.

3. The method according to claim 1, wherein the interleaving comprises iteratively inserting, into the interleaved image stream, a particular one of the frames of the first image stream, followed by a corresponding one of the frames of the first collection, followed by a particular one of the frames of the second image stream, followed by a corresponding one of the frames of the second collection.

4. The method according to claim 1, wherein the interleaving comprises iteratively inserting, into the interleaved image stream in a random order, a particular one of the frames of the first image stream, a corresponding one of the frames of the first collection, a particular one of the frames of the second image stream, and a corresponding one of the frames of the second collection.

5. The method according to claim 4, wherein the iteratively inserting, into the interleaved image stream in a random order, applies the random order to logical groupings of a particular one of the frames of the first image stream, a corresponding one of the frames of the first collection, a particular one of the frames of the second image stream, and a corresponding one of the frames of the second collection.

6. The method according to claim 1, further comprising varying a refresh rate of displaying the frames of the interleaved image stream on the single display.

7. The method according to claim 1, wherein the first image stream and the second image stream contain frames with sensitive content.

8. The method according to claim 1, further comprising:
applying an inverse of each frame of a third image stream to corresponding frames of a public image stream, thereby creating a third collection of frames;
the interleaving interleaves the frames of the third image stream and the third collection of frames with the first image stream, the first collection of frames, the frames of the second image stream, and the second collection of frames, thereby creating an interleaved image stream;
synchronizing a third pair of shutter glasses to open while the frames of third first image stream are displayed, from the interleaved image stream, on the single display, such that a wearer of the third pair of shutter glasses views only the third image stream; and
wherein the frames of the public image stream are viewable as a public view, from the interleaved image stream, for a viewer not wearing shutter glasses.

9. A computer program product for security management of displayed information, the computer program product comprising computer-readable code embodied on one or more computer-usable media, the computer-readable code comprising instructions that when executed on a computer cause the computer to:
apply an inverse of each frame of a first image stream to corresponding frames of a public image stream, thereby creating a first collection of frames;
apply an inverse of each frame of a second image stream to corresponding frames of the public image stream, thereby creating a second collection of frames;
interleave the frames of the first image stream, the first collection of frames, the frames of the second image stream, and the second collection of frames, thereby creating an interleaved image stream;
send a signal for synchronizing a first pair of shutter glasses to open while the frames of the first image stream are displayed, from the interleaved image stream, on the single display and to close otherwise, such that a wearer of the first pair of shutter glasses views only the first image stream;
send a signal for synchronizing a second pair of shutter glasses to open while the frames of the second image stream are displayed, from the interleaved image stream, on the single display and to close otherwise, such that a wearer of the second pair of shutter glasses views only the second image stream; and
wherein the frames of the public image stream are viewable as a public view, from the interleaved image stream, for a viewer not wearing shutter glasses.

10. A system for providing multiple interleaved views on a single display device, the system comprising:
the single display device;
an image stream comprising frames of a first image stream interleaved with frames of a second image stream, wherein the frames of the first image stream and the frames of the second image stream are sequentially related except in a portion thereof, the frames of the first image stream providing a first version of the portion and the frames of the second image stream providing a second version of the portion; and
a controller adapted for transmitting a first signal to a first pair of shutter glasses to synchronize the first pair of shutter glasses to open when the interleaved frames of the first image stream are displayed, from the image stream, on the single display device and to close otherwise, such that a wearer of the first pair of shutter glasses views only the first image stream and the first version of the portion and for transmitting a second signal to a second pair of shutter glasses to synchronize the second pair of shutter glasses to open when the interleaved frames of the second image stream are displayed, from the image stream, on the single display device and to close otherwise, such that a wearer of the second pair of shutter glasses views only the second image stream and the second version of the portion.

11. The system according to claim 10, wherein the first version provides closed captioning text in a first language and the second version provides closed captioning text in a second language.

12. The system according to claim 10, wherein the first version provides subtitles in a first language and the second version provides subtitles in a second language.

13. The system according to claim 10, wherein the frames of the first image stream and the frames of the second image stream comprise frames of a particular movie.

14. The system according to claim 10, wherein the first version provides closed captioning text for the frames and the second version omits the closed captioning text.

15. The system according to claim 10, wherein the first version provides subtitles for the frames and the second version omits the subtitles.

16. The system according to claim 10, wherein the image stream further comprises frames of a third image stream interleaved with the frames of the first image stream and the frames of the second image stream, wherein the frames of the third image stream are sequentially related to the frames of the first image stream and the frames of the second image stream except in the portion thereof, the frames of the third image stream providing a third version of the portion;
the controller is adapted for transmitting a third signal to a third pair of shutter glasses to synchronize the third pair of shutter glasses to open when the interleaved frames of the third image stream are displayed, from the image stream, on the single display device and to close otherwise, such that a wearer of the third pair of shutter glasses views only the third image stream and the third version of the portion.

17. The system according to claim 10, wherein the image stream is viewable, from the single display device, by a viewer not wearing shutter glasses, such that the viewer not wearing shutter glasses views the first and second portions as being blurred together.
